(19) United States
(12) Patent Application Publication
(10) Pub. No.: US 2013/0054377 A1
(43) Pub. Date: Feb. 28, 2013

(54) PERSON TRACKING AND INTERACTIVE ADVERTISING

(71) Applicants: Nils Oliver Krahnstoever, Brookline, MA (US); Peter Henry Tu, Niskayuna, NY (US); Ming-Ching Chang, Clifton Park, NY (US); Weina Ge, Niskayuna, NY (US)

(72) Inventors: Nils Oliver Krahnstoever, Brookline, MA (US); Peter Henry Tu, Niskayuna, NY (US); Ming-Ching Chang, Clifton Park, NY (US); Weina Ge, Niskayuna, NY (US)

(21) Appl. No.: 13/221,896

(22) Filed: Aug. 30, 2011

(51) Int. Cl. G06Q 30/02; G06K 9/00

(52) U.S. Cl. 705/14.66; 705/14.4; 382/103

(57) ABSTRACT

An advertising system is disclosed. In one embodiment, the system includes an advertising station including a display and configured to provide advertising content to potential customers via the display and one or more cameras configured to capture images of the potential customers when proximate to the advertising station. The system may also include a data processing system to analyze the captured images to determine gaze directions and body pose directions for the potential customers, and to determine interest levels of the potential customers in the advertising content based on the determined gaze directions and body pose directions. Various other systems, methods, and articles of manufacture are also disclosed.

### STATEMENT REGARDING FEDERALLY SPONSORED RESEARCH & DEVELOPMENT

This invention was made with Government support under grant number 2009-SQ-B9-K013 awarded by the National Institute of Justice. The Government has certain rights in the invention.

### BACKGROUND

The present disclosure relates generally to tracking of individuals and, in some embodiments, to the use of tracking data to infer user interest and enhance user experience in interactive advertising contexts.

Advertising of products and services is ubiquitous. Billboards, signs, and other advertising media compete for the attention of potential customers. Recently, interactive advertising displays that encourage user involvement have been introduced. While advertising is prevalent, it may be difficult to determine the efficacy of particular forms of advertising. For example, it may be difficult for an advertiser (or a client paying the advertiser) to determine whether a particular advertisement is effectively resulting in increased sales or interest in the advertised product or service. This may be particularly true of signs or interactive advertising displays. Because the effectiveness of advertising in drawing attention to, and increasing sales of, a product or service is important in deciding the value of such advertising, there is a need to better evaluate and determine the effectiveness of advertisements provided in such manners.

### BRIEF DESCRIPTION

Certain aspects commensurate in scope with the originally claimed invention are set forth below. It should be understood that these aspects are presented merely to provide the reader with a brief summary of certain forms various embodiments of the presently disclosed subject matter might take and that these aspects are not intended to limit the scope of the invention. Indeed, the invention may encompass a variety of aspects that may not be set forth below.

Some embodiments of the presently disclosed subject matter may generally relate to tracking of individuals. In certain embodiments, tracking data may be used in connection with an interactive advertising system. For example, in one embodiment a system includes an advertising station including a display and configured to provide advertising content to potential customers via the display and one or more cameras configured to capture images of the potential customers when proximate to the advertising station. The system may also include a data processing system including a processor and a memory having application instructions for execution by the processor, the data processing system configured to execute the application instructions to analyze the captured images to determine gaze directions and body pose directions for the potential customers, and to determine interest levels of the potential customers in the advertising content based on the determined gaze directions and body pose directions.

In another embodiment, a method includes receiving data on at least one of gaze directions or body pose directions of persons passing an advertising station displaying advertising content and processing the received data to infer interest levels of the persons in the advertising content displayed by the advertising station. In an additional embodiment, a method includes receiving image data from at least one camera and electronically processing the image data to estimate body pose direction and gaze direction of a person depicted in the image data independent of a direction of motion of the person.

In an additional embodiment, a manufacture includes one or more non-transitory, computer-readable media having executable instructions stored thereon. The executable instructions may include instructions adapted to receive data on gaze directions of persons passing an advertising station displaying advertising content, and to analyze the received data on gaze directions to infer interest levels of the persons in the advertising content displayed by the advertising station.

Various refinements of the features noted above may exist in relation to various aspects of the subject matter described herein. Further features may also be incorporated in these various aspects as well. These refinements and additional features may exist individually or in any combination. For instance, various features discussed below in relation to one or more of the illustrated embodiments may be incorporated into any of the described embodiments of the present disclosure alone or in any combination. Again, the brief summary presented above is intended only to familiarize the reader with certain aspects and contexts of the subject matter disclosed herein without limitation to the claimed subject matter.

### DRAWINGS

These and other features, aspects, and advantages of the present technique will become better understood when the following detailed description is read with reference to the accompanying drawings in which like characters represent like parts throughout the drawings, wherein:

FIG. 1 is a block diagram of an advertising system including an advertising station having a data processing system in accordance with an embodiment of the present disclosure;

FIG. 2 is a block diagram of an advertising system including a data processing system and advertising stations that communicate over a network in accordance with an embodiment of the present disclosure;

FIG. 3 is a block diagram of a processor-based device or system for providing the functionality described in the present disclosure and in accordance with an embodiment of the present disclosure;

FIG. 4 depicts a person walking by an advertising station in accordance with an embodiment of the present disclosure;

FIG. 5 is a plan view of the person and the advertising station of FIG. 4 in accordance with an embodiment of the present disclosure;

FIG. 6 generally depicts a process for controlling content output by an advertising station based on user interest levels in accordance with an embodiment of the present disclosure; and

FIGS. 7-10 are examples of various levels of user interest in advertising content output by an advertising station that may be inferred through analysis of user tracking data in accordance with certain embodiments of the present disclosure.

### DETAILED DESCRIPTION

One or more specific embodiments of the presently disclosed subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. When introducing elements of various embodiments of the present techniques, the articles “a,” “an,” “the,” and “said” are intended to mean that there are one or more of the elements. The terms “comprising,” “including,” and “having” are intended to be inclusive and mean that there may be additional elements other than the listed elements.

Certain embodiments of the present disclosure relate to tracking aspects of individuals, such as body pose and gaze directions. Further, in some embodiments, such information may be used to infer user interaction with, and interest in, advertising content provided to the user. The information may also be used to enhance user experience with interactive advertising content. Gaze is a strong indication of “focus of attention,” which provides useful information for interactivity. In one embodiment, a system jointly tracks body pose and gaze of individuals from both fixed camera views and using a set of Pan-Tilt-Zoom (PTZ) cameras to obtain high-quality views in high resolution. People's body pose and gaze may be tracked using a centralized tracker running on the fusion of views from both fixed and Pan-Tilt-Zoom (PTZ) cameras. But in other embodiments, one or both of body pose and gaze directions may be determined from image data of only a single camera (e.g., one fixed camera or one PTZ camera).

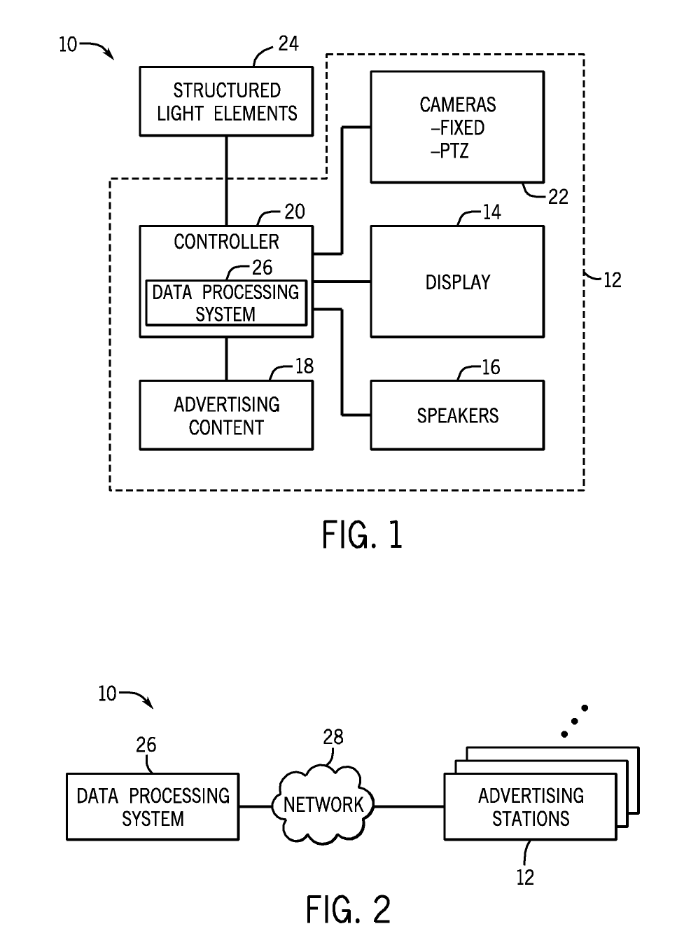

A system 10 is depicted in FIG. 1 in accordance with one embodiment. The system 10 may be an advertising system including an advertising station 12 for outputting advertisements to nearby persons (i.e., potential customers). The depicted advertising station 12 includes a display 14 and speakers 16 to output advertising content 18 to potential customers. In some embodiments, the advertising content 18 may include multi-media content with both video and audio. But any suitable advertising content 18 may be output by the advertising station 12, including video only, audio only, and still images with or without audio, for example.

The advertising station 12 includes a controller 20 for controlling the various components of the advertising station 12 and for outputting the advertising content 18. In the depicted embodiment, the advertising station 12 includes one or more cameras 22 for capturing image data from a region near the display 14. For example, the one or more cameras 22 may be positioned to capture imagery of potential customers using or passing by the display 14. The cameras 22 may include either or both of at least one fixed camera or at least one PTZ camera. For instance, in one embodiment, the cameras 22 include four fixed cameras and four PTZ cameras.

Structured light elements 24 may also be included with the advertising station 12, as generally depicted in FIG. 1. For example, the structured light elements 24 may include one or more of a video projector, an infrared emitter, a spotlight, or a laser pointer. Such devices may be used to actively promote user interaction. For example, projected light (whether in the form of a laser, a spotlight, or some other directed light) may be used to direct the attention of a user of the advertising system 12 to a specific place (e.g., to view or interact with specific content), may be used to surprise a user, or the like. Additionally, the structured light elements 24 may be used to provide additional lighting to an environment to promote understanding and object recognition in analyzing image data from the cameras 22. Although the cameras 22 are depicted as part of the advertising station 12 and the structured light elements 24 are depicted apart from the advertising station 12 in FIG. 1, it will be appreciated that these and other components of the system 10 may be provided in other ways. For instance, while the display 14, one or more cameras 22, and other components of the system 10 may be provided in a shared housing in one embodiment, these components may be also be provided in separate housings in other embodiments.

Further, a data processing system 26 may be included in the advertising station 12 to receive and process image data (e.g., from the cameras 22). Particularly, in some embodiments, the image data may be processed to determine various user characteristics and track users within the viewing areas of the cameras 22. For example, the data processing system 26 may analyze the image data to determine each person's position, moving direction, tracking history, body pose direction, and gaze direction or angle (e.g., with respect to moving direction or body pose direction). Additionally, such characteristics may then be used to infer the level of interest or engagement of individuals with the advertising station 12.

Although the data processing system 26 is shown as incorporated into the controller 20 in FIG. 1, it is noted that the data processing system 26 may be separate from the advertising station 12 in other embodiments. For example, in FIG. 2, the system 10 includes a data processing system 26 that connects to one or more advertising stations 12 via a network 28. In such embodiments, cameras 22 of the advertising stations 12 (or other cameras monitoring areas about such advertising stations) may provide image data to the data processing system 26 via the network 28. The data may then be processed by the data processing system 26 to determine desired characteristics and levels of interest by imaged persons in advertising content, as discussed below. And the data processing system 26 may output the results of such analysis, or instructions based on the analysis, to the advertising stations 12 via the network 28.

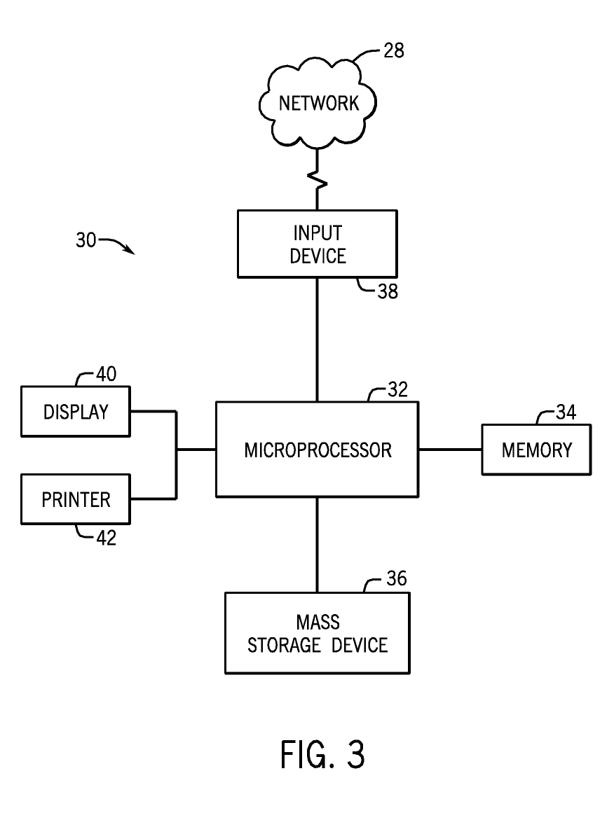

Either or both of the controller 20 and the data processing system 26 may be provided in the form of a processor-based system 30 (e.g., a computer), as generally depicted in FIG. 3 in accordance with one embodiment. Such a processor-based system may perform the functionalities described in this disclosure, such as the analysis of image data, the determination of body pose and gaze directions, and the determination of user interest in advertising content. The depicted processor-based system 30 may be a general-purpose computer, such as a personal computer, configured to run a variety of software, including software implementing all or part of the functionality described herein. Alternatively, the processor-based system 30 may include, among other things, a mainframe computer, a distributed computing system, or an application-specific computer or workstation configured to implement all or part of the present technique based on specialized software and/or hardware provided as part of the system. Further, the processor-based system 30 may include either a single processor or a plurality of processors to facilitate implementation of the presently disclosed functionality.

In general, the processor-based system 30 may include a microcontroller or microprocessor 32, such as a central processing unit (CPU), which may execute various routines and processing functions of the system 30. For example, the microprocessor 32 may execute various operating system instructions as well as software routines configured to effect certain processes. The routines may be stored in or provided by an article of manufacture including one or more non-transitory computer-readable media, such as a memory 34 (e.g., a random access memory (RAM) of a personal computer) or one or more mass storage devices 36 (e.g., an internal or external hard drive, a solid-state storage device, an optical disc, a magnetic storage device, or any other suitable storage device). In addition, the microprocessor 32 processes data provided as inputs for various routines or software programs, such as data provided as part of the present techniques in computer-based implementations.

Such data may be stored in, or provided by, the memory 34 or mass storage device 36. Alternatively, such data may be provided to the microprocessor 32 via one or more input devices 38. The input devices 38 may include manual input devices, such as a keyboard, a mouse, or the like. In addition, the input devices 38 may include a network device, such as a wired or wireless Ethernet card, a wireless network adapter, or any of various ports or devices configured to facilitate communication with other devices via any suitable communications network 28, such as a local area network or the Internet. Through such a network device, the system 30 may exchange data and communicate with other networked electronic systems, whether proximate to or remote from the system 30. The network 28 may include various components that facilitate communication, including switches, routers, servers or other computers, network adapters, communications cables, and so forth.

Results generated by the microprocessor 32, such as the results obtained by processing data in accordance with one or more stored routines, may be reported to an operator via one or more output devices, such as a display 40 or a printer 42. Based on the displayed or printed output, an operator may request additional or alternative processing or provide additional or alternative data, such as via the input device 38. Communication between the various components of the processor-based system 30 may typically be accomplished via a chipset and one or more busses or interconnects which electrically connect the components of the system 30.

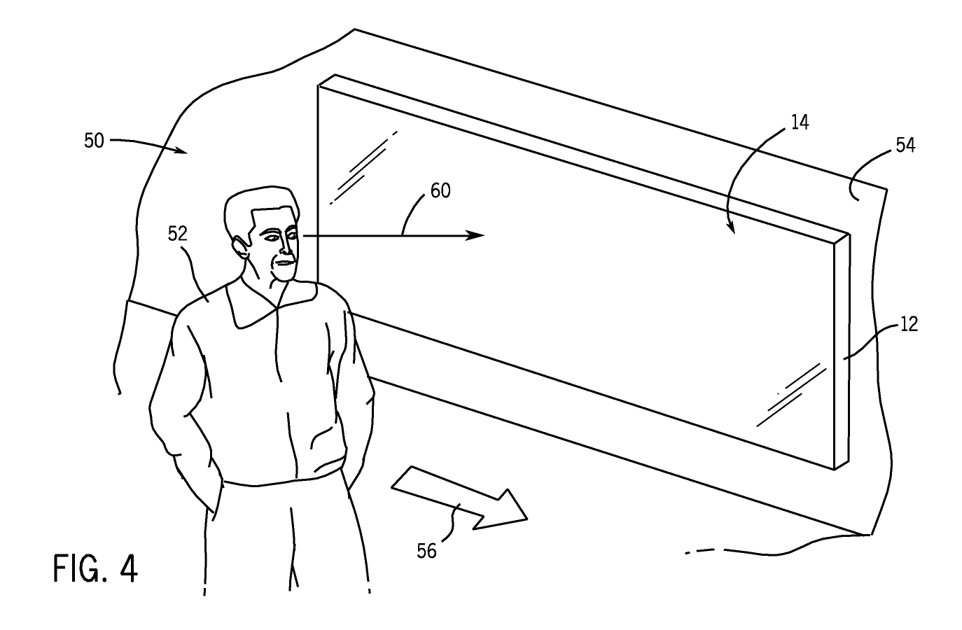

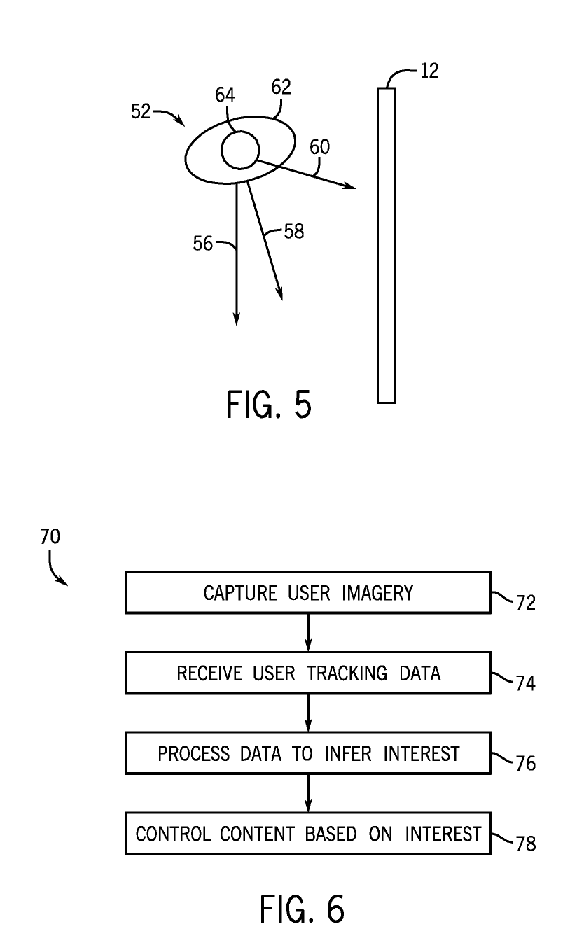

Operation of the advertising system 10, the advertising station 12, and the data processing system 26 may be better understood with reference to FIG. 4, which generally depicts an advertising environment 50, and FIG. 5. In these illustrations, a person 52 is passing an advertising station 12 mounted on a wall 54. One or more cameras 22 (FIG. 1) may be provided in the environment 50 and capture imagery of the person 52. For instance, one or more cameras 22 may be installed within the advertising station 12 (e.g., in a frame about the display 14), across a walkway from the advertising station 12, on the wall 54 apart from the advertising station 12, or the like. As the person 52 walks by the advertising station 12, the person 52 may travel in a direction 56. Also, as the person 52 walks in the direction 56, the body pose of the person 52 may be in a direction 58 (FIG. 5) while the gaze direction or the person 52 may be in a direction 60 toward display 14 of the advertising station 12 (e.g., the person may be viewing advertising content on the display 14). As best depicted in FIG. 5, while the person 52 travels in the direction 56, the body 62 of the person 52 may be turned in a pose facing in the direction 58. Likewise, the head 64 of the person 52 may be turned in the direction 60 toward the advertising station 12 to allow the person 52 to view advertising content output by the advertising station 12.

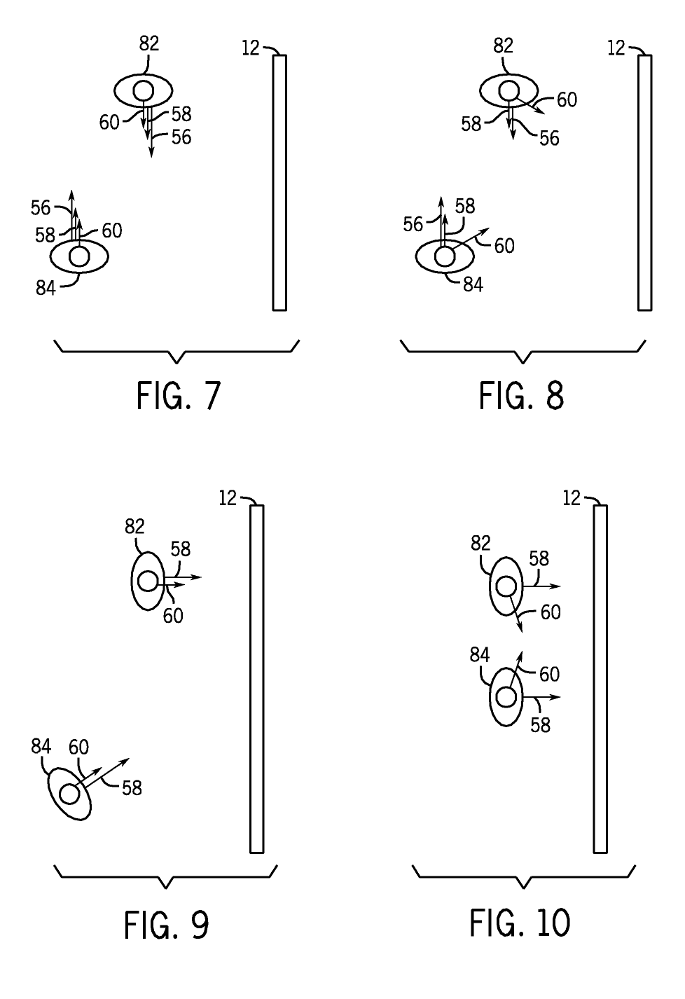

A method for interactive advertising is generally depicted as a flowchart 70 in FIG. 6 in accordance with one embodiment. The system 10 may capture user imagery (block 72), such as via the cameras 22. The imagery thus captured may be stored for any suitable length of time to allow processing of such images, which may include processing in real-time, near real-time, or at a later time. The method may also include receiving user tracking data (block 74). Such tracking data may include those characteristics described above, such as one or more of gaze direction, body pose direction, direction of motion, position, and the like. Such tracking data may be received by processing the captured imagery (e.g., with the data processing system 26) to derive such characteristics. But in other embodiments the data may be received from some other system or source. One example of a technique for determining characteristics such as gaze direction and body pose direction is provided below following the description of FIGS. 7-10.

Once received, the user tracking data may be processed to infer a level of interest in output advertising content by potential customers near the advertising station 12 (block 76). For instance, either or both of body pose direction and gaze direction may be processed to infer interest levels of users in content provided by the advertising station 12. Also, the advertising system 10 may control content provided by the advertising station 12 based on the inferred level of interest of the potential customers (block 78). For example, the advertising station 12 may update the advertising content to encourage new users to view or begin interacting with the advertising station if users are showing minimal interest in the output content. Such updating may include changing characteristics of the displayed content (e.g., changing colors, characters, brightness, and so forth), starting a new playback portion of the displayed content (e.g., a character calling out to passersby), or selecting different content altogether (e.g., by the controller 20). If the level of interest of nearby users is high, the advertising station 12 may vary the content to keep a user's attention or encourage further interaction.

The inference of interest by one or more user or potential customers may be based on analysis of the determined characteristics and better understood with reference to FIGS. 7-10. For example, in the embodiment depicted in FIG. 7, a user 82 and a user 84 are generally depicted walking by the advertising station 12. In this depiction, the travel directions 56, the body pose directions 58, and the gaze directions 60 of the users 82 and 84 are generally parallel to the advertising station 12. Thus, in this embodiment the users 82 and 84 are not walking toward the advertising station 12, their body poses are not facing toward advertising station 12, and the users 82 and 84 are not looking at advertising station 12. Consequently, from this data, the advertising system 10 may infer that the users 82 and 84 are not interested or engaged in the advertising content being provided by the advertising station 12.

In FIG. 8, the users 82 and 84 are traveling in their respective travel directions 56 with their respective body poses 58 in similar directions. But their gaze directions 60 are both toward the advertising station 12. Given the gaze directions 60, the advertising system 10 may infer that the users 82 and 84 are at least glancing at the advertising content being provided by the advertising station 12, exhibiting a higher level of interest than in the scenario depicted in FIG. 7. Further inferences may be drawn from the length of time that the users view the advertising content. For example, a higher level of interest may be inferred if a user looks toward the advertising station 12 for longer than a threshold amount of time.

In FIG. 9, the users 82 and 84 may be in stationary positions with body pose directions 58 and gaze directions 60 toward the advertising station 12. By analyzing imagery in such an occurrence, the advertising system 10 may determine that the users 82 and 84 have stopped to view, and infer that the users are more interested in, the advertising being displayed on the advertising station 12. Similarly, in FIG. 10, users 82 and 84 may both exhibit body pose directions 58 toward the advertising station 12, may be stationary, and may have gaze directions 60 generally facing each other. From such data, the advertising system 10 may infer that the users 82 and 84 are interested in the advertising content being provided by the advertising station 12 and, as the gaze directions 60 are generally toward the opposite user, also that the users 82 and 84 are part of a group collectively interacting with or discussing the advertising content. Similarly, depending on the proximity of the users to the advertising station 12 or displayed content, the advertising system could also infer that users are interacting with content of the advertising station 12. It will be further appreciated that position, movement direction, body pose direction, gaze direction, and the like may be used to infer other relationships and activities of the users (e.g., that one user in a group first takes interest in the advertising station and draws the attention of others in the group to the output content).

### EXAMPLE

As noted above, the advertising system 10 may determine certain tracking characteristics from the captured image data. One embodiment for tracking gaze direction by estimating location, body pose, and head pose direction of multiple individuals in unconstrained environments is provided as follows. This embodiment combines person detections from fixed cameras with directional face detections obtained from actively controlled Pan-Tilt-Zoom (PTZ) cameras and estimates both body pose and head pose (gaze) direction independently from motion direction, using a combination of sequential Monte Carlo Filtering and MCMC (i.e., Markov chain Monte Carlo) sampling. There are numerous benefits in tracking body pose and gaze in surveillance. It allows to track people's focus of attention, can optimize the control of active cameras for biometric face capture, and can provide better interaction metrics between pairs of people. The availability of gaze and face detection information also improves localization and data association for tracking in crowded environments. While this technique may be useful in an interactive advertising context as described above, it is noted that the technique may be broadly applicable to a number of other contexts.

Detecting and tracking individuals under unconstrained conditions such as in mass transit stations, sport venues, and schoolyards may be important in a number of applications. On top of that, the understanding of their gaze and intention are more challenging due to the general freedom of movements and frequent occlusions. Moreover, face images in standard surveillance videos are usually low-resolution, which limits the detection rate. Unlike some previous approaches that at most obtained gaze information, in one embodiment of the present disclosure multi-view Pan-Tilt-Zoom (PTZ) cameras may be used to tackle thd problem of joint, holistic tracking of both body pose and head orientation in real-time. It may be assumed that the gaze can be reasonably derived by head pose in most cases. As used below, “head pose” refers to gaze or visual focus of attention, and these terms may be used interchangeably. The coupled person tracker, pose tracker, and gaze tracker are integrated and synchronized, thus robust tracking via mutual update and feedback is possible. The capability to reason over gaze angle provides a strong indication of attention, which may be beneficial to a surveillance system. In particular, as part of interaction models in event recognition, it may be important to know if a group of individuals are facing each other (e.g., talking), facing a common direction (e.g., looking at another group before a conflict is about to happen), or facing away from each other (e.g., because they are not related or because they are in a “defense” formation).

The embodiment described below provides a unified framework to couple multi-view person tracking with asynchronous PTZ gaze tracking to jointly and robustly estimate pose and gaze, in which a coupled particle filtering tracker jointly estimates body pose and gaze. While person tracking may be used to control PTZ cameras, allowing performance of face detection and gaze estimation, the resulting face detection locations may in turn be used to further improve tracking performance. In this manner, track information can be actively leveraged to control PTZ cameras in maximizing the probability of capturing frontal facial views. The present embodiment may be considered to be an improvement over previous efforts that used the walking direction of individuals as an indication of gaze direction, which breaks down in situations where people are stationary. The presently disclosed framework is general and applicable to many other vision-based applications. For example, it may allow optimal face capture for biometrics, particularly in environments where people are stationary, because it obtains gaze information directly from face detections.

In one embodiment, a network of fixed cameras are used to perform sitewide person tracking. This person tracker drives one or more PTZ cameras to target individuals to obtain close-up views. A centralized tracker operates on the groundplane (e.g., a plane representative of the ground on which target individuals move) to fuse together information from person tracks aid face tracks. Due to the large computational burden on inferring gaze from face detections, the person tracker and face tracker may operate asynchronously to run in real-time. The present system can operate on either a single or multiple cameras. The multi-camera setting may improve overall tracking performance in crowded conditions. Gaze tracking in this case is also useful in performing high-level reasoning, e.g., to analyze social interactions, attention model, and behaviors.

Each individual may be represented with a state vector s=[x, v, α, φ, θ], where x is the location on the (X,Y) groundplane metric world, v is the velocity on the groundplane, α is the horizontal orientation of the body around the groundplane normal, φ is the horizontal gaze angle, and θ is the vertical gaze angle (positive above the horizon and negative below it). There are two types of observations in this system: person detections (z, R), where z is a groundplane location measurement and R the uncertainty of this measurement, and face detections (z, R, γ, ρ) where the additional parameters γ and ρ are the horizontal and vertical gaze angles. Each person's head and foot locations are extracted from image-based person detections and backprojected onto the world headplane (e.g., a plane parallel to the groundplane at head level of the person) and groundplane respectively, using an unscented transform (UT). Next, face positions and poses in PTZ views are obtained using a PittPatt face detector. Their metric world groundplane locations are again obtained through back-projection. Face pose is obtained by matching face features. Individual's gaze angles are obtained by mapping face pan and rotation angles in image space into the world space. Finally, the world gaze angles are obtained by mapping the image local face normal n_{img} into world coordinates via n_{w}=n_{img}R^{-T}, where R is the rotation matrix of the projection P=[R|t]. Observation gaze angles (γ, ρ) are obtained directly from this normal vector. Width and height of the face are used to estimate a covariance confidence level for the face location. The covariance is projected from the image to the ground-plane again using the UT from the image to the head plane, followed by down projection to the groundplane.

In contrast to previous efforts in which a person's gaze angle was estimated independently from location and velocity and body pose was ignored, the present embodiment correctly models the relationship between motion direction, body pose, and gaze. First, in this embodiment body pose is not strictly tied to motion direction. People can move backwards and sideways especially when people are waiting or standing in groups (albeit, with increasing velocity sideways people's motion becomes improbable, and at even greater velocities, only forward motion may be assumed). Secondly, head pose is not tied to motion direction, but there are relatively strict limits on what pose the head can assume relative to body pose. Under this model the estimation of body pose is not trivial as it is only loosely coupled to gaze angle and velocity (which in turn is only observed indirectly). The entire state estimation may be performed using a Sequential Monte Carlo filter. Assuming a method for associating measurements with tracks over time, for the sequential Monte Carlo filter, the following are specified below: (i) the dynamical model and (ii) the observation model of our system.

Dynamical Model: Following the description above, the state vector is s=[x, v, α, φ, θ] and the state prediction model decomposes as follows:

p(sₜ₊₁|st)=p(qₜ₊₁|qₜ)p(αₜ₊₁|vₜ₊₁,αₜ)

p(φₜ₊₁|φₜ,αₜ₊₁)p(θₜ₊₁|θₜ), (1)

using the abbreviation q=(x, v)=(x, y, vₓ, v_{y}). For the location and velocity we assume a standard linear dynamical model

p(qₜ₊₁|qₜ)= [symbol] (qₜ₊₁−Fₜqₜ,Qₜ), (2)

where [symbol] denotes Normal distribution, F, is a standard constant velocity state predictor corresponding to xₜ₊₁=xₜ+vₜΔt and Qₜ the standard system dynamics. The second term in Eq. (1) describes the propagation of the body pose under consideration of the current velocity vector. We assume the following model

$$p ( {α}_{t + 1} \vert {v}_{t + 1} {α}_{t} ) = N ( {α}_{t + 1} - {α}_{t} , {σ}_{α} ) \cdot \{ \begin{matrix}( 1.0 - {P}^{o} ) N ( {α}_{t + 1} - {v}_{t + 1} , {σ}_{v α} ) + {P}^{o} \frac{1}{2 π} & & if \vert \vert v \vert \vert > 2 m \text{/} s , \\ \frac{1}{2 π} & or & if \vert \vert v \vert \vert < \frac{1}{2} m \text{/} s , \\ {P}^{f} N ( {α}_{t + 1} - {v}_{t + 1} , {σ}_{v α} ) + {P}^{b} N ( {α}_{t + 1} - {v}_{t + 1} - π , {σ}_{v α} ) + {P}^{o} \frac{1}{2 π} & & otherwise ,\end{matrix} \qquad ( 3 )$$

where P^{f}=0.8 is the probability (for medium velocities 0.5 m/s<v<2 m/s) of a person walking forwards, P^{b}=0.15 the probability (for medium velocities) of walking backwards, and P^{o}=0.05 the background probability allowing arbitrary pose to movement direction relationships, based on experimental heuristics. With vₜ₊₁ we denote the direction of the velocity vector vₜ₊₁ and with σ_{vα} the expected distribution of deviations between movement vector and body pose. The front term N (αₜ₊₁−αₜ, σ_{α}) represents the system noise component, which in turn limits the change in body pose over time. All changes in pose are attributed to deviations from the constant pose model.

The third term in Eq. (1) describes the propagation of the horizontal gaze angle under consideration of the current body pose. We assume the following model

$$p ( {φ}_{t + 1} \vert {φ}_{t} {α}_{t + 1} ) = N ( {φ}_{t + 1} - {φ}_{t} , {σ}_{φ} ) \cdot \{ {P}_{g}^{u} Θ ( \vert {φ}_{t + 1} - \frac{π}{3} \vert ) + {P}_{g} N ( {φ}_{t + 1} - {α}_{t + 1} , {σ}_{αφ} ) \} , \qquad ( 4 )$$

where the two terms weighted by P_{g}^{u}=0.4 and P_{g}=0.6 define a distribution of the gaze angle (φₜ₊₁) with respect to body pose (αₜ₊₁) that allows arbitrary values within a range of

$${α}_{t + 1} \pm \frac{π}{3}$$

but favors distribution around body pose. Finally the fourth term in Eq. (1) describes the propagation of the tilt angle, p(θₜ₊₁|θₜ)= [symbol] (θₜ₊₁, σ_{θ}^{o}) [symbol] (θₜ₊₁−θₜ, σ_{θ}), where the first term models that a person tends to favor horizontal directions and the second term represents system noise. Noted that in all above equations, care has to be taken with regard to angular differences.

To propagate the particles forward in time, we need to sample from the state transition density Eq. (1), given a previous set of weighted samples (sₜⁱ, wₜⁱ). While for the location, velocity and vertical head pose, this is easy to do. The loose coupling between velocity, body pose and horizontal head pose is represented by a non-trivial set of transition densities Eq. (3) and Eq. (4). To generate samples from these transition densities we perform two Markov Chain Monte Carlo (MCMC). Exemplified on Eq. (3), we use a Metropolis sampler to obtain a new sample as follows:
Start: Set αₜ₊₁ⁱ[0] to be the αₜⁱ of particle i.
Proposal Step: Propose a new sample αₜ₊₁ⁱ[k+1] by sampling from a jump-distribution G(α|αₜ₊₁ⁱ[k]).
Acceptance Step: Set r=p(αₜ₊₁ⁱ[k+1]|vₜ₊₁αₜⁱ)/p(αₜ₊₁ⁱ[k]|vₜ₊₁αₜⁱ). If r≧1, accept the new sample. Otherwise accept it with probability r. If it is not accepted, set αₜ₊₁ⁱ+1[k+1]=αₜ₊₁ⁱ[k].
Repeat: Until k=N steps have been completed.

Typically only a small fixed number of steps (N=20) are performed. The above sampling is repeated for the horizontal head angle in Eq. (4). In both cases the jump distribution is set equal to the system noise distribution, except with a fraction of the variance i.e., G(α|αₜ₊₁ⁱ|[k])= [symbol] (α−αₜ₊₁ⁱ[k], σ_{α}/3) for body pose; G(φ|φₜ₊₁ⁱ[k]) and G(θ|θₜ₊₁[k]) are defined similarly. The above MCMC sampling ensures that only particles that adhere both to the expected system noise distribution as well to the loose relative pose constraints are generated. We found 1000 particles are sufficient.

Observation Model: After sampling the particle distribution (sₜⁱ,wₜⁱ) according to its weights {wₜⁱ} and forward propagation in time (using MCMC as described above), we obtain a set of new samples {sₜ₊₁ⁱ}. The samples are weighted according to the observation likelihood models described next. For the case of person detections, the observations are represented by (zₜ₊₁, Rₜ₊₁) and the likelihood model is:

p(zₜ₊₁|sₜ₊₁)= [symbol] (zₜ₊₁−xₜ₊₁|Rₜ₊₁) (5)

For the case of face detection (zₜ₊₁, Rₜ₊₁, γₜ₊₁, ρₜ₊₁), the observation likelihood model is

p(zₜ₊₁,γₜ₊,ρₜ₊₁|sₜ₊₁)= [symbol] (zₜ₊₁−xₜ₊₁|Rₜ₊₁)

[symbol]

(λ((γₜ₊₁,ρₜ₊₁),(φₜ₊₁,θₜ₊₁)),σ_{λ}), (6)

where λ(.) is the geodesic distance (expressed in angles) between the points on the unit circle represented by the gaze vector (φₜ₊₁,θₜ₊₁) and the observed face direction (γₜ₊₁,ρₜ₊₁) respectively.

λ((γₜ₊₁;ρₜ₊₁):(φₜ₊₁;θₜ₊₁))=arceos(sin ρₜ₊₁ sin θₜ₊₁+cos ρₜ₊₁ cos θₜ₊₁ cos(γₜ₊₁−φₜ₊₁)).

The value σ_{λ} is the uncertainty that is attributed to the face direction measurement. Overall the tracking state update process works as summarized in Algorithm 1:
Data: Sample set Sₜ=(wₜⁱ, sₜⁱ)
Result: Sample set Sₜ₊₁=(wₜ₊₁ⁱ,sₜ₊₁ⁱ)
begin

for i=1, . . . , M(number of particles)do
Randomly select sample sₜⁱ=(xₜⁱ, vₜⁱ, αₜⁱ, φᵢⁱ, θᵢⁱ) from Sₜ according to weights wₜⁱ
Obtain forward propagated locations xₜ₊₁ⁱ and vₜ₊₁ⁱ by sampling from distribution Eq. (2).
Perform MCMC to sample a new body pose αₜ₊₁ⁱ from Eq. (3).
Perform MCMC to sample a new horizontal gaze vector φₜ₊₁ⁱ from Eq. (4).
Sample new vertical face angle θₜ₊₁ⁱ from distribution ρ(θₜ₊₁ⁱ|θₜ)
Evaluate new state wₜ₊₁ⁱ=p(Zₜ₊₁|sₜ₊₁ⁱ) with Eq. (5) if the observation is a person detection, or Eq. (6) if it is a directional face detection. Renormalize particle set to obtain final update distribution Sₜ₊₁=(wₜ₊₁ⁱ,sₜ₊₁ⁱ).
   end

### Algorithm 1

Data Association: So far we assumed that observations had already been assigned to tracks. In this section we will elaborate how observation to track assignment is performed. To enable the tracking of multiple people, observations have to be assigned to tracks over time. In our system, observations arise asynchronously from multiple camera views. The observations are projected into the common world reference frame, under consideration of the (possibly time varying) projection matrices, and are consumed by a centralized tracker in the order that the observations have been acquired. For each time step, a set of (either person or face) detections Zₜ^{l} have to be assigned to tracks sₜ^{k}. We construct a distance measure Cₖₗ=d(sₜ^{k}, Zₜ^{j}) to determine the optimal one-to-one assignment of observations l to tracks k using Munkres algorithm. Observations that do not get assigned to tracks might be confirmed as new targets and are used to spawn new candidate tracks. Tracks that do not get detections assigned to them are propagated forward in time and thus do not undergo weight update.

The use of face detections leads to an additional source of location information that may be used to improve tracking. Results show that this is particularly useful in crowded environments, where face detectors are less susceptible to person-person occlusion. Another advantage is that the gaze information introduces an additional component into the detection-to-track assignment distance measure, which works effectively to assign oriented faces to person tracks.

For person detections, the metric is computed from the target gate as follows:

$${μ}_{t}^{k} = \frac{1}{N} {Σ}_{i} {x}_{t}^{ki} , {Σ}_{t}^{kl} = \frac{1}{N - 1} {Σ}_{i} ( {x}_{t}^{ki} - {μ}_{t}^{k} ) {( {x}_{t}^{ki} - {μ}_{t}^{k} )}^{T} + {R}_{tl}^{l}$$

where Rₜ^{l} is the location covariance of observation l and xₜ^{ki} is the location of the i^{th} particle of track k at time t. The distance measure is then given as:

Cₖₗ^{l}=(μₜ^{k}−zₜ^{l})^{T}(Σₜ^{kl})⁻¹(μₜ^{k}−zₜ^{l})+log|Σₜ^{kl}|

For face detections, the above is augmented by an additional term for the angle distance:

$${C}_{kl} = {C}_{kl}^{l} + \frac{λ ( ( {γ}_{t}^{l} , {ρ}_{t}^{l} ) , ( {μ}_{φ t}^{k} , {μ}_{Θ t}^{k} ) {0}^{2}}{{σ}_{λ}^{2}} + log {σ}_{λ}^{2} ,$$

where the μ_{φt}^{k} and μ_{φt}^{k} are computed from the first order spherical moment of all particle gaze angles angular mean); σ_{λ} is the standard deviation from this moment; (γₜ^{l}, pₜ^{l}) are the horizontal and vertical gaze observation angles in observation l. Since only PTZ cameras provide face detections and only fixed cameras provide person detections, data association is performed with either all person detections or all face detections; the gaze of mixed associations does not arise.

Technical effects of the invention include improvements in tracking of users and in allowing the determination of user interest levels in advertising content based on such tracking. In an interactive advertising context, the tracked individuals may be able to move freely in an unconstrained environment. But by fusing the tracking information from various camera views and determining certain characteristics, such as each person's position, moving direction, tracking history, body pose, and gaze angle, for example, the data processing system 26 may estimate each individual's instantaneous body pose and gaze by smoothing and interpolating between observations. Even in the cases of missing observation due to occlusion or missing steady face captures due to the motion blur of moving PTZ cameras, the present embodiments can still maintain the tracker using a “best guess” interpolation and extrapolation over time. Also, the present embodiments allow determinations of whether a particular individual has strong attention or has interest at the ongoing advertising program (e.g., currently interacting with the interactive advertising station, just passing by or has just stopped to play with the advertising station). Also, the present embodiments allow the system to directly infer if a group of people are together interacting with the advertising station (e.g., Is someone currently discussing with peers (revealing mutual gazes), asking them to participate, or inquiring parent's support of purchase?). Further, based on such information, the advertising system can optimally update its scenario/content to best address the level of involvement. And by reacting to people's attention, the system also demonstrates strong capability of intelligence, which increases popularity and encourages more people to try interacting with the system.

While only certain features of the invention have been illustrated and described herein, many modifications and changes will occur to those skilled in the art. It is, therefore, to be understood that the appended claims are intended to cover all such modifications and changes as fall within the true spirit of the invention.

1.-5. (canceled)

6. A method comprising:
receiving data on at least one of gaze directions or body pose directions of persons passing an advertising station displaying advertising content; and
processing the received data to infer interest levels of the persons in the advertising content displayed by the advertising station.

7. The method of claim 6, comprising the advertising station automatically updating the advertising content based on the inferred interest levels of the persons passing the advertising station.

8. The method of claim 7, wherein updating the advertising content includes selecting different advertising content to be displayed by the advertising station.

9. The method of claim 6, wherein receiving data on at least one of gaze directions or body pose directions includes receiving data on gaze directions, and processing the received data to infer interest levels of the persons includes detecting that at least one person looked toward the advertising station for longer than a threshold amount of time.

10. The method of claim 6, wherein receiving data on at least one of gaze directions or body pose directions includes receiving data on both gaze directions and body pose directions, and processing the received data includes processing the received data on gaze directions and body pose directions to infer the interest levels of the persons in the advertising content.

11. The method of claim 10, wherein processing the received data on gaze directions and body poses includes determining that a group of persons are collectively interacting with the advertising station.

12. The method of claim 11, wherein processing the received data on gaze directions and body poses includes determining that at least two people are conversing about the advertising station.

13. The method of claim 10, wherein processing the received data on gaze directions and body poses includes determining whether persons are interacting with the advertising station.

14. The method of claim 6, comprising projecting a beam of light from a structured light source to a region to guide at least one person to view the region or interact with content displayed in the region.

15. A method comprising:
receiving image data from at least one camera; and
electronically processing the image data to estimate body pose direction and gaze direction of a person depicted in the image data independent of a direction of motion of the person.

16. The method of claim 15, wherein receiving image data from at least one camera includes receiving image data from only a single, fixed camera, and electronically processing the image data includes electronically processing the image data from only the single, fixed camera.

17. The method of claim 15, wherein receiving image data from at least one camera includes receiving image data from multiple cameras, and electronically processing the image data includes electronically processing the image data from each of at least two cameras of the multiple cameras.

18. The method of claim 17, comprising capturing the image data using at least one fixed camera and at least one Pan-Tilt-Zoom camera in an unconstrained environment.

19. The method of claim 18, comprising tracking the person based on data from the at least one fixed camera and controlling the at least one Pan-Tilt-Zoom camera based on the tracking of the person to capture closer views of the person and facilitate the estimation of the gaze direction.

20. The method of claim 19, comprising using face detection locations resulting from the control of the at least one Pan-Tilt-Zoom camera to improve tracking performance using the at least one fixed camera.

21. The method of claim 17, wherein receiving image data from multiple cameras includes receiving image data of an area next to an advertising station.

22. The method of claim 15, wherein processing the image data to estimate body pose direction and gaze direction includes using a Sequential Monte Carlo filter.

23. A manufacture comprising:
one or more non-transitory, computer-readable media having executable instructions stored thereon, the executable instructions comprising:
instructions adapted to receive data on gaze directions of persons passing an advertising station displaying advertising content; and
instructions adapted to analyze the received data on gaze directions to infer interest levels of the persons in the advertising content displayed by the advertising station.

24. The manufacture of claim 23, wherein the one or more non-transitory, computer-readable media comprise a plurality of non-transitory, computer-readable media at least collectively having the executable instructions stored thereon.

25. The manufacture of claim 23, wherein the one or more non-transitory, computer-readable media include a storage medium or a random access memory of a computer.
